(19) United States
(12) Patent Application Publication
(10) Pub. No.: US 2012/0089830 A1
(43) Pub. Date: Apr. 12, 2012

(54) METHOD AND DEVICE FOR DIGITALLY ATTESTING THE AUTHENTICITY OF BINDING INTERACTIONS

(76) Inventors: Mohamed M. Kande, Preverenges (CH); Arnaud Burlet, Pully (CH)

(21) Appl. No.: 13/259,906

(22) PCT Filed: May 20, 2009
(86) PCT No.: PCT/EP09/56193

§ 371 Date: Dec. 30, 2011

(30) Foreign Application Priority Data
Mar. 25, 2009 (EP) PCTEP2009053488

(51) Int. Cl. H04L 29/06; H04L 9/00

(52) U.S. Cl. 713/155

(57) ABSTRACT

Method for digitally attesting the authenticity of an interaction, comprising the steps of establishing a secure digital communication channel between a Universal Signature Assistant and a remote Attestation Appliance, sending an interaction request to a remote site, digitally receiving from the remote Attestation Appliance on the Universal Signature Assistant an attestation request for the authenticity of said interaction request, confirming or denying the authenticity of the interaction request by respectively accepting or rejecting the attestation request on said Universal Signature Assistant. Device for digitally attesting the authenticity of an interaction, comprising a Universal Signature Assistant comprising a CPU, a memory, a storage, a system bus, said CPU, the memory and the storage being connected to the system bus for communicating with each other, a display connected to the system bus for displaying information to a user, a user input device connected to the system bus for allowing the user entering information to the Universal Signature Assistant, a communication interface connected to the system bus for communicating with external devices, a reader for reading user identity information contained on an identity token and a software program stored in the storage for performing the method of the invention with the Universal Signature Assistant when the software program is run by the CPU.

### FIELD OF THE INVENTION

The present invention relates to a method and a device for attesting the authenticity of interactions. The present invention relates in particular to a method and a device for enabling individuals and/or organizations to digitally attest the authenticity of any kind of binding interaction such as for example transfer of confidential documents, instructions for mandate execution including for example instructions for postal delivery, renewal and modification of contracts, etc.

### BACKGROUND OF THE INVENTION

There is no business without signature, specifically when it comes to the establishment of binding agreements. However, despite the rapid adoption of the Internet as probably the most powerful distribution and communication channel, there is no effective and well-accepted digital solution to enable attesting the authenticity of binding interactions of any kind.

Most current security solutions are tightly bound to specific applications: A security solution for an e-banking application, for example, cannot be re-used for confidential document transfer without major complications.

A consequence of the growing recognition of the Internet as a critical infrastructure is that more and more criminals engage in cybercrime to take advantage of the financial gains they can realize. A major weakness exploited in such cybercrime attacks is the fact that untrusted computers continue to play a key role in most electronic transactions.

Indeed, prior art authentication methods rely on the authentication of a user either online, for example directly on the remote server of an organization such as a private company or a public administration, or offline with an application running locally on the user's personal computer.

These prior art methods usually rely on the introduction, by the user, of an identifier such as a username and one or more secrets such as a password and/or a key that should be available only to the user. The key is for example to be chosen by the user in a list of keys in response to a challenge from the remote site or from the local application, or to be read on a dongle which is physically separated from the user's personal computer and displays a new key at regular intervals. Once the user's identity is authenticated, a secure communication channel is usually established between the user's computer and the organization's server, and all the following interactions established over this communication channel are considered as authentic.

Since the Internet is ownerless, borderless and its components cannot be trusted, a drawback of prior art online authentication methods is that there is no guarantee that the information exchanged between the user's computer and the other party, for example the organization's server, during the authentication process is not intercepted by a third party engaging in cybercrime and using the transmitted information for his or her own benefit. A skilled third party could for example use the authentication information sent by the user for placing himself as an intermediary between the user and the organization, and then intercept and modify the subsequently exchanged information which the initial parties would still believe to be authentic.

Offline authentication methods, on the other hand, rely on the user's computer which is at least occasionally connected to the Internet and could thus be infected by spywares or other pieces of software that can fetch the authentication information and send it to a third party that could again use it for his or her own benefit.

Prior art authentication method are therefore probably very efficient for systems that have well-defined boundaries, but they are subject to fraudulent misuse in distributed and relatively unsecure networks such as for example the Internet.

Furthermore, the lack of flexibility of some prior art solutions forces Internet users to perform every step of their electronic transactions online. Nowadays, many steps of an electronic transaction have to be completed online, making such an operation rigid, complicated and time-consuming.

### SUMMARY OF THE INVENTION

An aim of the present invention is thus to provide a method and a device for improving the safety of binding interactions of any kind, in particular of binding interactions over an electronic communication network.

Another aim of the present invention is to provide a method and a device for reliably attesting the authenticity of information remotely exchanged by two or more parties.

Still another aim of the present invention is to provide a method and a device allowing for an increased flexibility in the conclusion of binding interactions of any kind.

Still another aim of the present invention is to provide a method and a device allowing the traceability of binding interactions and their authentications.

These aims are solved by a method and a device comprising the features of the corresponding independent claims, variant embodiments being described in the dependent claims.

These aims are solved in particular by a method for digitally attesting the authenticity of an interaction, comprising the steps of establishing a secure digital communication channel between a Universal Signature Assistant and a remote Attestation Appliance, sending an interaction request to a remote site, digitally receiving from the remote Attestation Appliance on the Universal Signature Assistant an attestation request for the authenticity of said interaction request, confirming or denying the authenticity of the interaction request by respectively accepting or rejecting the attestation request on said Universal Signature Assistant.

These aims are solved also by a device for digitally attesting the authenticity of an interaction, comprising a Universal Signature Assistant comprising a CPU, a memory, a storage, a system bus, the CPU, the memory and the storage being connected to the system bus for communicating with each other, a display connected to the system bus for displaying information to a user, a user input device connected to the system bus for allowing the user entering information to the Universal Signature Assistant, a communication interface connected to the system bus for communicating with external devices, a reader for reading user identity information contained on an identity token and a software program stored in the storage for performing the method of the invention with the Universal Signature Assistant when the software program is run by the CPU.

The invention introduces a Universal Signature Assistant that can be used effectively in all kinds of situations where a binding agreement is needed and in which decoupling decision making from the execution of the decision is desired.

According to the method and device of the invention, the authenticity of binding interactions of any kind is attested in an application-independent way, as opposed to prior art application-dependent access control systems, thus reducing both the costs and complexity of concluding binding agreements. Furthermore, the method and device of the invention allow attesting the authenticity of binding interactions offline, no matter where the parties are, instead of confirming electronic transactions online. This increases the mobility and flexibility of parties when concluding binding agreements of any kind.

An advantage of the method and device of the invention is that its deployment is totally application-independent. This allows organizations to avoid wasting resources in information security investments which often become quickly obsolete and it liberates these organizations from uncertainties in making such investments.

### BRIEF DESCRIPTION OF THE DRAWINGS

The invention is described in more details below, and illustrated by the figures where:

FIG. 1 schematically represents a device according to a preferred embodiment of the invention;

FIG. 2 illustrates a preferred embodiment of the method of the invention.

### DETAILED DESCRIPTION OF THE INVENTION

According to a preferred embodiment of the invention, the authenticity of binding interactions is attested with the help of a Universal Signature Assistant. The Universal Signature Assistant is for example embedded in a dedicated casing thus forming a standalone electronic device, or integrated in another electronic device such as for example a mobile phone, a laptop, a PDA, or any other, preferably portable, electronic device. The electronic device comprising the Universal Signature Assistant 15 is preferably a mobile handheld device that the user can easily carry around.

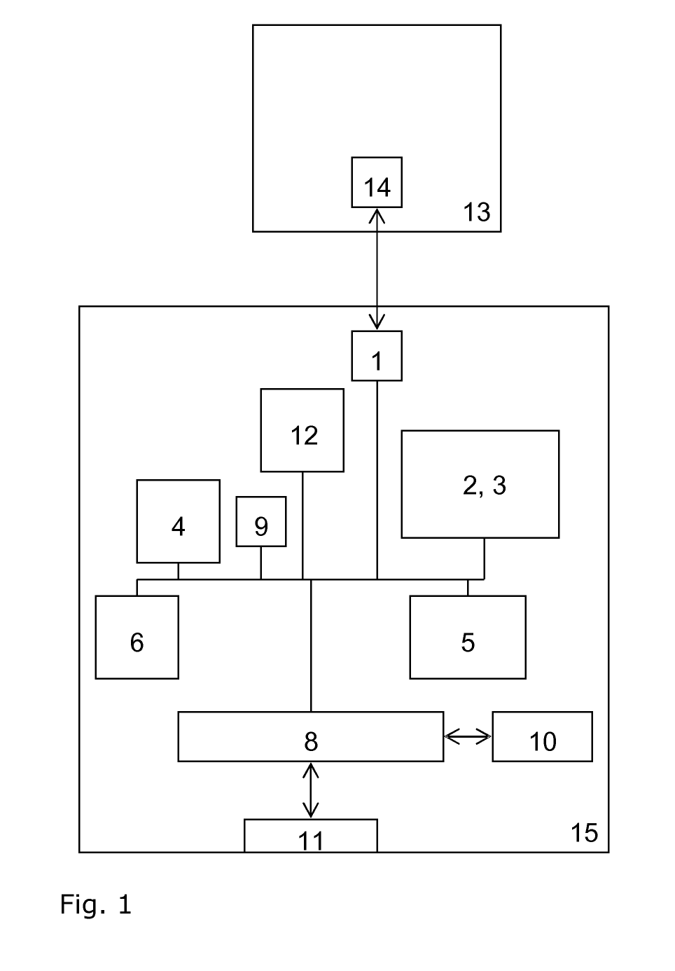

FIG. 1 schematically illustrates, by way of non-limiting example, a preferred embodiment of the Universal Signature Assistant 15 of the invention.

According to this embodiment, the Universal Signature Assistant 15 comprises a Central Processing Unit (CPU) 4, a memory 5 and a storage 6, communicating with each other over a system bus 7. The CPU 4 controls the other electronic elements of the Universal Signature Assistant 15 using pieces of software and/or data stored in the storage 5 and/or in the memory 6.

The Universal Signature Assistant 15 further comprises, directly or indirectly connected to the system bus 7, a display 2 for displaying information to a user and a user input device 3 for allowing the user entering information to the Universal Signature Assistant 15. The input device 3 comprises for example one or more pushbuttons and/or an alphanumeric keyboard. In a variant embodiment, the display 2 and the user input device 3 are at least partly combined into a touch screen.

The Universal Signature Assistant 15 also comprises a communication interface 8 for communicating with external electronic devices, through a direct connection with said external electronic devices and/or through a distributed communication network. The communication interface 8 is connected for example to an antenna 10 for communicating wirelessly using Bluetooth, Wi-Fi, GSM, UMTS, or any other adapted wireless protocol and/or to a wired connector 11 such as a USB, FireWire, Ethernet and/or any other suitable wired connector for communicating using the corresponding protocol.

Preferably, the Universal Signature Assistant 15 comprises a cryptographic co-processor 9 for encrypting at least part of the data that is sent over the communication interface 8 and/or for decrypting possibly encrypted received data. In a variant embodiment, encryption and/or decryption are performed by the CPU 4.

The Universal Signature Assistant 15 further comprises a reader 1, for example a smart card reader, a barcode reader, a magnetic strip reader, an RFID reader, etc., for reading information contained on an identity token 14, for example a smartcard chip, a barcode, a magnetic strip, and RFID chip, etc. The identity token 14 is preferably placed on an adapted support 13 physically separated from the device comprising the Universal Signature Assistant 15. The support 13 is for example a plastic card of a standard format such as the credit card format, for facilitating the storage and/or transport of the identity token 14, and/or for facilitating, for example, its insertion into the Universal Signature Assistant 15 in order to have its content read by the reader 1.

In a preferred embodiment, the Universal Signature Assistant 15 further comprises an authentication device 12 connected to the system bus 7, for example a biometric authentication device such as a fingerprint reader, a retina reader, etc. for allowing the authentication of the identity of a user.

The Universal Signature Assistant 15 also comprises a software program stored in the storage 6 and/or in the memory 5 for performing the method of the invention described below when run by the CPU 4.

The identity token 14 is preferably personal to a single user who uses it to identify himself for example by inserting it into, or by sweeping it in front of the Universal Signature Assistant 15, wherein the information contained in the identity token 14 is read by the reader 1. The information read by the reader 1 is then processed for example by the CPU 4 to determine the identity of the user.

In a preferred embodiment, in order to verify whether the determined identity corresponds to the identity of the actual user of the Universal Signature Assistant 15, the user will be requested to authenticate his identity with the help of the authentication device 12, for example by sweeping his finger on it, presenting his eye in front of it, etc. The read biometric data is processed and compared with previously stored biometric data corresponding to the user identified with the identity token 14. The stored biometric data is for example stored in the storage 6 and/or in the identity token 14. If the biometric data read with the authentication device 12 matches the stored biometric data, the previously determined identity of the user is considered as authentic and the Universal Signature Assistant 15 is activated with the parameters of the corresponding user's profile. These parameters include for example the access rights to some critical information, the editing rights for some interaction parameters, etc.

In the present example, the identity read from the identity token 14 is authenticated with the help of a biometric authentication device 12. Even though this authentication method provides nearly optimal level of security, other authentication methods are possible within the frame of the invention. In particular, the user can for example authenticate his identity by introducing a password with the help of the input device 3.

Advantageously, the single Universal Signature Assistant 15 of the invention can be successively activated with one or more identity token 14, each identity token containing information about the identity of another user. The Universal Signature Assistant 15 then preferably stores a different user profile for each identity. Different users can thus, one at a time, use a same Universal Signature Assistant 15, which is preferably activated with their own user profile.

The display 2 is used for displaying information to the user, for example during the authentication of a binding interaction according to the method of the invention. The content and nature of the displayed information preferably depends on the actual step of the authentication method and the nature of the binding interaction.

For example, when the user is requested to attest the authenticity of an interaction, the displayed information comprises distinctive and undeniable characteristics of the interaction, such as the key terms and conditions of a contract, which allow identifying the interaction. This information is displayed to the user for him to review prior to attesting the authenticity of the interaction. The user then preferably attests the authenticity of the interaction by entering a corresponding instruction through the user input device 3, for example by pushing a dedicated pushbutton.

According to the invention, the Universal Signature Assistant 15 allows a user digitally attesting the authenticity of any electronic interaction between himself and a remote site, the remote site being any other party, for example another user such as a business partner, or an organization such as a postal service or an insurance company, a public administration, etc. The interaction is for example a contractual agreement or a transfer of confidential documents. The particulars of the interaction, such as the contract, the documents to be transferred, etc., are for example prepared on a personal computer or on another electronic device, while the authenticity of the interaction itself is attested directly from the Universal Signature Assistant 15. The authenticity of the interaction is thus attested from a secure and trusted device instead of being attested from a personal computer or any other device that can not be trusted.

Once the authenticity of the interaction is attested from the Universal Signature Assistant 15 by the user using the method of the invention explained below, the information relative to the interaction is preferably transmitted through an end-to-end encrypted communication channel. The encrypted communication channel is established over one or more communication networks between the Universal Signature Assistant 15 and the remote site, for example the computer or the Universal Signature Assistant of another user, the server of an organization or of a public administration, etc. The communication intermediaries such as for example the user's personal computer, antennas, Internet service providers and/or access providers are thus only used as relays that have neither any right nor any possibility to access the data transmitted over the encrypted communication channel, thus avoiding capture and/or falsification of the transmitted information by an unauthorized third party.

The device of the invention also allows digitally attesting the authenticity of a non-electronic interaction, for example of contractual agreements prepared on paper or any other support, orders made over the phone or by fax, etc. According to the invention, the authenticity of the non-electronic interaction is digitally attested with the help of the Universal Signature Assistant 15, instead of being attested for example by apposing a manuscript signature on a contract or by confirming phone or fax orders by mail.

Preferably, two different usage modes of the Universal Signature Assistant 15 are supported for at least some steps of the method of the invention for digitally attesting the authenticity of an interaction: online and offline. In the online mode, the Universal Signature Assistant 15 is connected to an electronic communication network, either directly or through another electronic communication device such as for example a computer, a mobile phone, etc., while in the offline mode the Universal Signature Assistant 15 is completely disconnected from any communication network.

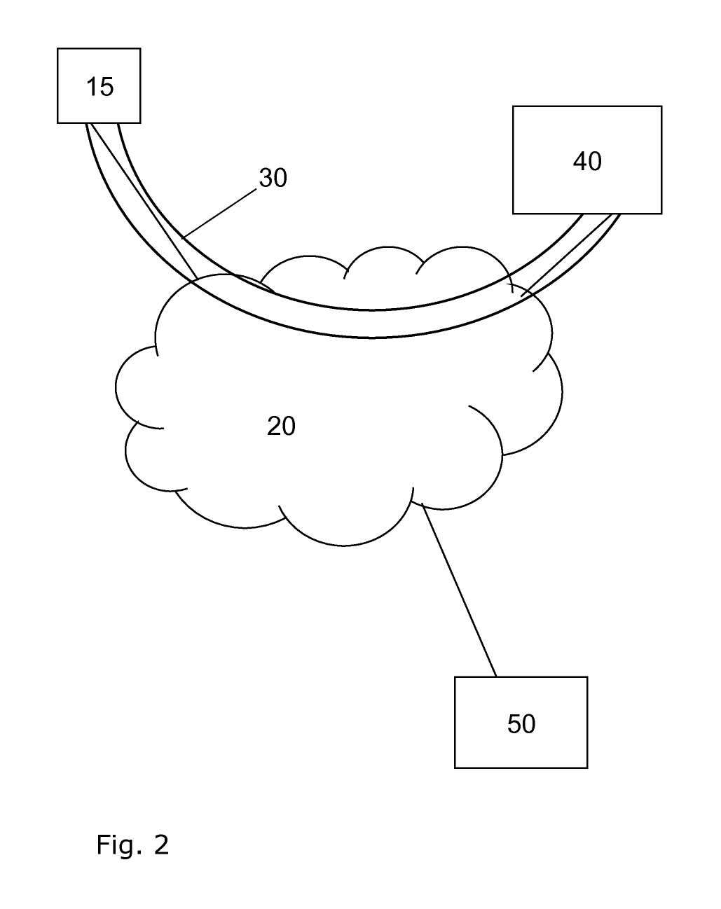

According to a preferred embodiment of the invention illustrated in FIG. 2, the method of the invention for attesting the authenticity of an interaction comprises the following steps, once the Universal Signature Assistant 15 is activated:

a secure digital communication channel 30 is established, for example over a distributed communication network 20 such as the Internet, between the Universal Signature Assistant 15 and a remote Attestation Appliance 40,

an interaction request is sent to a remote site 50, for example from the Universal Signature Assistant 15,

an attestation request sent by the remote Attestation Appliance 40 is digitally received on said Universal Signature Assistant 15, the attestation request requesting the user of the Universal Signature Assistant 15 to attest the authenticity of the previously sent interaction request,

the relevant information about the interaction and the attestation requests are preferably displayed to the user who then confirms or denies the authenticity of the interaction request by respectively accepting or rejecting the attestation request on the Universal Signature Assistant 15.

In a preferred embodiment, the remote Attestation Appliance 40 is a remote computer accessible over a communications network 20 such as for example the Internet. The Attestation Appliance 40 is preferably managed by a third party, which is typically independent from the user and from the remote site 50. The Attestation Appliance 40 is for example managed by a service provider with whom the user and/or the remote site 50 have entered a service agreement for digitally attesting interactions.

In a variant embodiment, however, the Attestation Appliance 40 is run by one of the parties to the interaction, in particular by the remote site 50, for example by the organization or the public administration with which the user wishes to establish an interaction.

According to the invention, the Attestation Appliance 40 receives information from the remote site 50 about the interaction request sent by the user. The Attestation Appliance 40 preferably automatically analyses this information and issues a corresponding attestation request which is sent to the user's Universal Signature Assistant 15. The attestation request typically comprises some relevant information about the interaction such as the key elements of a contract, the document ID and the recipient of a confidential document, etc., which is displayed to the user on the Universal Signature Assistant 15. If the displayed information corresponds to the information sent by the user in the interaction request, the user accepts the attestation request. Otherwise, or in case of doubt, he preferably rejects it.

Once the attestation request is either accepted or rejected by the user, this information is sent to the remote site 50. The information whether the user accepted or rejected the attestation request is preferably sent over secure communication channels from the Universal Signature Assistant 15 to the Attestation Appliance 40, and then from the Attestation Appliance 40 to the remote site 50. Alternatively, this information is communicated directly from the Universal Signature Assistant 15 to the remote site 50, preferably over a secure communication channel.

If the attestation request was accepted by the user, the remote site 50 considers the corresponding interaction request, which was previously received from the user, as authentic. If necessary, the remaining required information about the interaction is then securely exchanged between the Universal Signature Assistant 15 and the remote site 50 over a secure communication channel, for example digitally transmitted over an encrypted communication channel.

If the attestation request is rejected by the user because the displayed information doesn't correspond to the content of a previously sent interaction request, for example because the interaction request was intercepted and/or modified by a third party, or because the interaction request was originated from a third party, then the remote site 50 ignores and possibly deletes or stores for further enquiry any corresponding previously received interaction request.

In an implementation example of the method of the invention, binding agreements or interactions to be signed by one or more parties are treated in the following way:

an administrative person, for example, preferably using his or her own identity token 14, activates a Universal Signature Assistant 15 and downloads a list of attestation requests, i.e. a list of requests to attest the authenticity of corresponding binding agreements or interactions, from a remote Attestation Appliance 40;

the list of attestation requests is transferred to and stored on the Universal Signature Assistant 15, which is preferably directly connected to a communication network through its communication interface 8 and antenna 10, thus avoiding any treatment of the information through an untrusted computer;

a first party activates the Universal Signature Assistant 15 using his or her own identity token 14, reviews said attestation requests that are stored on the Universal Signature Assistant 2 in either an online or an offline mode and accepts or rejects them, thereby confirming or not the authenticity of the corresponding interactions;

each of the subsequent parties, if any, who need to attest the authenticity of said interactions, for example associates and/or the director of the first party, activate the Universal Signature Assistant 15 with his or her own identity token 14, preferably sees whether other parties previously accepted or rejected the interaction requests and in turn accepts or rejects them;

the administrative person uploads a list of the interaction requests that were accepted, and thus considered as authentic, by all required parties, without having the right of viewing the list of said interaction requests or their key characteristics, and sends this list either to the remote Attestation Appliance 40 or to the remote site 50.

Preferably, any attempt to read the interaction data from a computer requires an explicit confirmation given by the initiator of the interaction or by the owner of the interaction data.

In the present description, an attestation request means a request to attest the authenticity of an interaction between a user and one or more other parties, for example one or more other users, organizations and/or public administrations.

Under interaction is to be understood a reciprocal action, effect or influence in which two or more parties exchange data or any kind of information, or act together or towards each other or with others to achieve a binding agreement.

Interaction data is information or data of any type that is exchanged in the context of an interaction, for example but not exclusively, information about the parties, statements, contracts, messages, reports and confidential documents.

In another implementation example, the method and the device of the invention are used for creating and confirming an instruction for a mandate execution.

In this example, the user activates the Universal Signature Assistant 15. Preferably, the Universal Signature Assistant 15 is activated using an identity token 14, so that only an authorized and identified user can activate it and the corresponding user profile is automatically loaded.

The Universal Signature Assistant 15 then connects to a communication network, either directly or through another electronic communication device such as a personal computer or a mobile telephone, for example. The Universal Signature Assistant 15 and a remote Attestation Appliance 40 establish a secure-communication channel over the communication network.

The user creates, for example on his computer, a mandate execution request with all the required information, and sends it to a remote site such as the remote application server of the other party, for example of an organization or of a public administration. The application server requests confirmation of the authenticity of the received mandate execution request to the Attestation Appliance 40.

The Attestation Appliance 40 builds a corresponding attestation request with the available mandate data and sends it to the Universal Signature Assistant 15. If foreseen by the profile of the current user, data relative to the attestation request is displayed on the display 2, comprising for example the mandate's essential features such as the identity of the parties, keywords of a document, instructions, etc. The user confirms or rejects the authenticity of the mandate by accepting or rejecting the attestation request using the user input device 3.

The Universal Signature Assistant 15 sends the confirmation status to the Attestation Appliance 40. The Attestation Appliance 40 verifies the validity of the confirmation status and notifies the application server, or remote site 50, about the confirmation status and its validity. The remote site 50 in turn notifies the user's computer whether the mandate was confirmed or not.

In another implementation example, the device and method of the invention are used for the transfer of a confidential document.

The user first activates the Universal Signature Assistant 15 using his own identity token 14. The Universal Signature Assistant 15 connects to a communication network, either directly or through another electronic device, and establishes a secure communication channel with a remote Attestation Appliance.

The user uses for example a computer to create a document request which is then sent to a remote site, for example an application server of the other party involved in the interaction such as a business partner. The application server transmits the document to the Attestation Appliance, which builds an attestation request and attaches the document to it. The Attestation Appliance then sends the attestation request and the document to the Universal Signature Assistant 15 via the secure communication channel.

The attestation request is displayed on the display 2 with, for example, some information sufficient to identify the attached document, so that the user can determine whether this is the document that he requested. The user uses the Universal Signature Assistant 15 to accept or reject the attestation request.

If the attestation request is accepted, the document is stored on the Universal Signature Assistant 15, and the user for example chooses whether the document is to be transmitted to his computer or the Universal Signature Assistant 15 notifies the computer that the document is available. The user gets access to the document using his computer or, if the document is to be accessed using the Universal Signature Assistant 15, the user gets access to the document using the Universal Signature Assistant 15.

If the attestation request is rejected, the document is removed from the Universal Signature Assistant 15.

The Universal Signature Assistant 15 sends the confirmation status to the Attestation Appliance via the secure communication channel. The Attestation Appliance verifies the validity of the confirmation status and notifies the application server about the confirmation status and its validity. Optionally, the application server notifies the user's computer whether the document was transferred or not.

In still another example, the method and device of the invention are used to grant or refuse remote access to a document.

The user first activates the Universal Signature Assistant 15 using his own identity token 14. The Universal Signature Assistant 15 connects to a communication network, either directly or through another electronic device, and establishes a secure communication channel with a remote Attestation Appliance.

The user uses for example a computer to open a special document folder logically linked to the Universal Signature Assistant 15, the computer and the Universal Signature Assistant 15 being connected to each other either directly, for example via a Bluetooth or USB connection, or indirectly over a distributed communication network. The computer requests the folder content, i.e. a list of documents, to the Universal Signature Assistant 15. The Universal Signature Assistant 15 requests the user to confirm whether it's allowed to give the document list to the computer.

If the user confirms the request, the Universal Signature Assistant 15 sends the request for the list of documents and the confirmation status from the user to the Attestation Appliance. The Attestation Appliance verifies the request and the confirmation status and sends the request for the list of documents and the confirmation status to the application server. The application server sends the list of documents to the Attestation Appliance which transmits the list of documents to the Universal Signature Assistant 15.

The Universal Signature Assistant sends the list of documents to the computer which displays it.

The user uses the computer to open a document from the list.

The computer requests the document's content from the Universal Signature Assistant 15. The Universal Signature Assistant 15 requests the user to confirm whether it's allowed to give the document content to the computer.

If the user confirms the request, the Universal Signature Assistant 15 sends the document's content request and the confirmation status to the Attestation Appliance. The Attestation Appliance verifies the request and the confirmation status and sends the document's content request and the confirmation status to the application server. The application server sends the document's content to the Attestation Appliance which in turn transmits the document's content to the Universal Signature Assistant 15. The Universal Signature Assistant 15 sends the document's content to the user's computer which displays it.

If the user refuses the request, the interaction is stopped.

The next example describes a possible use of the method and the device of the invention in an interaction involving multiple users.

In a first part, a first user is a user with a low privilege level. The first user activates the Universal Signature Assistant using his own identity token 14. The Universal Signature Assistant 15 connects to a communication network, either directly or through another electronic device, and establishes a secure communication channel with a remote Attestation Appliance over the communication network.

The first user uses for example his computer to create an interaction request which is sent to another party's remote application server.

Preferably, the application server requests a confirmation from the

Attestation Appliance. The Attestation Appliance builds an attestation request and sends it to the Universal Signature Assistant 15. The first user uses the Universal Signature Assistant 15 to confirm or reject the attestation request. The Universal Signature Assistant 15 sends the confirmation status to the Attestation Appliance.

The Attestation Appliance verifies the validity of the confirmation status and notifies the application server about the confirmation status and its validity. If the interaction was authenticated, i.e. if the first user confirmed the attestation request, the interaction data is saved on the application server, which notifies the computer.

The first user then uses for example the computer to trigger the sending of a list of one or more interactions to be approved and/or signed by one or more parties.

The application server sends the list to the Attestation Appliance, which in turn sends it to the Universal Signature Assistant 15. The Universal Signature Assistant 15 stores the list for later use and the Attestation Appliance notifies the application server that the interactions-to-sign list was successfully sent. The application server then possibly notifies the first user's computer that the interactions-to-sign list was successfully sent.

In a second part, a second user is a user with a high privilege level.

The second user activates the Universal Signature Assistant 15 using his own identity token 14. The Universal Signature Assistant 15 is preferably not connected to any communication network, and as such is said to be offline.

The Universal Signature Assistant 15 offers the second user to approve and/or sign a first interaction from the interactions-to-sign list that is stored on it, by displaying a corresponding attestation request on the display 2. The second user accepts the offer using the user input device 3 and repeats the following two actions for each further transaction to approve and/or sign:
1. the Universal Signature Assistant 15 displays interaction data for approval and/or signature;
2. the user confirms or not the authenticity of the interaction.

The Universal Signature Assistant 15 then preferably displays the list of interactions with their associated approved or rejected status.

This second step is repeated for each user with a high privilege level or party who needs to approve the interactions.

In a third part, the first user or another user activates the Universal Signature Assistant 15. The Universal Signature Assistant notifies the first user that the interactions-to-sign list has to be sent back. The Universal Signature Assistant 15 connects to a communication network, either directly or through another electronic device, and establishes a secure communication channel with a remote Attestation Appliance over the communication network.

The first user uses for example a computer or the Universal Signature Assistant 15 to request the sending of the interactions-to-sign list. The corresponding request is sent to the application server, which requests the interactions-to-sign list from the Attestation Appliance. The Attestation Appliance builds a request and sends it to the Universal Signature Assistant 15.

The Universal Signature Assistant 15 sends the completed interactions-to-sign list with the respective approved or rejected status to the Attestation Appliance. The Universal Signature Assistant notifies the first user that the list is being sent. The Attestation Appliance verifies the validity of the confirmation status and notifies the application server about the confirmation status and its validity. The application server possibly notifies the computer that the Universal Signature Assistant successfully sent the interactions-to-sign list.

In still another example, the device and method of the invention are used to digitally attest the authenticity of a web interaction.

A user mandates a service provider, for example his bank, via an untrusted communication channel such as the Internet or a telephone network. The service provider having an agreement with an Attestation Appliance sends an attestation request to the Attestation Appliance. The Attestation Appliance sends the attestation request to the user's Universal Signature Assistant 15 over a secure communication channel. The attestation request is displayed on the display 2 of the Universal Signature Assistant 15 and the user confirms or rejects it, thus attesting or not the authenticity of the mandate. The confirmation status is then sent back from the Universal Signature Assistant 15 to the Attestation Appliance which in turn forwards it to the service provider. The service provider then executes the mandate or ignores it, depending on the confirmation status received from the Attestation Appliance.

In the next example, the device and method of the invention are used to digitally attest the authenticity of an interaction initiated for example on the phone.

A user mandates a service provider over the phone. The service provider has no direct access to an Attestation Appliance but has an agreement with a trusted attestation provider that has a direct connection to an Attestation Appliance. The service provider requests, for example by phone, fax or any other communication channel, the attestation provider to authenticate the received mandate. The attestation provider contacts the Attestation Appliance, which builds an attestation requests and sends it over a secure communication channel to the user's Universal Signature Assistant 15. The attestation request is displayed on the display 2 of the Universal Signature Assistant 15 and the user confirms or rejects it, thus attesting or not the authenticity of the mandate. The confirmation status is then sent back from the Universal Signature Assistant 15 to the Attestation Appliance which in turn forwards it to the attestation provider. The attestation provider communicates the confirmation status to the service provider, for example by phone, fax or any other communication channel, which then executes the mandate or ignores it depending on the confirmation status received from the attestation provider.

In the next example, the device and method of the invention are used to digitally attest the authenticity of a document transfer between parties.

In a first part, a first user activates a Universal Signature Assistant using his own identity token. The Universal Signature Assistant 15 connects to a communication network, either directly or through another electronic device, and establishes a secure communication channel with a remote Attestation Appliance over the communication network.

The first user then uses for example his computer to select a confidential document and to create a request for the transfer of the confidential document to one or more recipients. The computer sends the request to a remote application server which sends the recipients' public identities to the Attestation Appliance. The Attestation Appliances builds an attestation request with the list of the recipients, and sends it to the Universal Signature Assistant of the first user. The first user attests or rejects the request with his Universal Signature Assistant. If the first user attested the authenticity of the recipient's list, the Universal Signature Assistant notifies the first user to upload the confidential document. The first user then uses for example his computer for opening a secured document folder that is preferably logically linked to the Universal Signature Assistant.

In order to upload the document, the first user uses for example his computer to copy the confidential document into the secured document folder. The computer then uploads the confidential document into the Universal Signature Assistant, which in turns notifies the first user of the receipt of the document for example by displaying this information on the display and/or emitting an acoustic signal. The Universal Signature Assistant preferably offers the first user to review the received document by displaying its distinctive features, and to confirm the authenticity of the document. If the user confirms the authenticity of the document, the Universal Signature Assistant preferably encrypts the document and stores it for a later transfer. If the user doesn't confirm the authenticity of the document, the document is erased from the Universal Signature Assistant.

The Universal Signature Assistant then possibly offers the first user to upload another confidential document or to send the stored document(s). If the first user requests the Universal Signature Assistant to send the stored document(s), the Universal Signature Assistant sends the preferably signed and encrypted document(s) with an attested list of recipients to the application server, which stores the document(s) and the list of recipients and confirm reception to the Attestation Appliance. The Attestation Appliance sends a confirmation of receipt to the Universal Signature Assistance, which notifies the first user about it, for example by displaying a corresponding message on the display.

In a second part, a second user is one of the recipients of the confidential document. The second user activates a second Universal Signature Assistant using his own identity token. The second Universal Signature Assistant 15 connects to a communication network, either directly or through another electronic device, and establishes a secure communication channel with the remote Attestation Appliance over the communication network.

The second user uses for example a computer for creating a request for the reception of the confidential document. The request is sent to the application server. The application server then sends the requested document to the Attestation Appliance, which in turn sends it to the second Universal Signature Assistant over the secure communication channel.

The second Universal Signature Assistant verifies the authenticity of the received document. If the authenticity of the received document can't be confirmed, the process is interrupted. Otherwise, the second Universal Signature Assistant notifies the second user about the receipt of the confidential document. The second user uses for example his computer to open a secured document folder that is logically linked to the second Universal Signature Assistant. The computer requests the folder content from the second Universal Signature Assistant. The second Universal Signature Assistant requests the second user to confirm whether the folder content (documents list) can be transmitted to the computer.

If the second user confirms the request, the second Universal Signature Assistant sends the list of stored confidential document(s) to the computer which displays it. The second user opens a confidential document from the list on his computer. The computer thus requests the content of the document from the second Universal Signature Assistant, which preferably again requests second user to confirm whether the content of the requested document can be transmitted to the computer. If the second user confirms the request, the second Universal Signature Assistant decrypts the content of the document and sends it to the computer which for example displays it on its screen.

In still another implementation example, the device and method of the invention are used to create and digitally attest the authenticity of an offline transaction, where a user's computer is not connected to any communication network.

In a first part, the user activates a Universal Signature Assistant using his own identity token, and connects it to his computer over a local connection. The user uses a specific application running on the computer to create an offline transaction. The computer sends the transaction data to the Universal Signature Assistant. The user then uses his Universal Signature Assistant to confirm or reject the transaction. If the transaction is confirmed, it is stored in the Universal Signature Assistant.

In a second part, the Universal Signature Assistant 15 connects to a communication network, either directly or through the user's computer or another electronic device, and establishes a secure communication channel with a remote Attestation Appliance over the communication network.

The user uses the Universal Signature Assistant to send the transaction that was created offline and stored on the Universal Signature Assistant. The Universal Signature Assistant sends the stored transaction with its confirmation status to the Attestation Appliance. The Attestation Appliance verifies the validity of the confirmation status and notifies a remote application server about the received transaction and its status. The remote application server stores the confirmed transaction for execution and notifies the Attestation Appliance about its successful reception. The Attestation Appliance sends the reception status to the Universal Signature Assistant over the secured communication channel and the Universal Signature Assistant notifies the user about the successful transmission of the transaction by displaying a corresponding message.

Alternatively, several transactions can be created offline in the first part and transmitted as a single batch in the second part.

In the above examples, the Attestation Appliance is a remote entity independent from the parties to the interaction, i.e. from the user and from the application server. Even though this is a preferred solution for security and simplicity purposes, other configurations are possible within the frame of the invention. In particular, the Attestation Appliance could be managed by the same organization that manages the application server.

It is also possible within the frame of the invention, to have more than one Attestation Appliance, wherein the Attestation Appliance used for authenticating a particular interaction depends upon the type of interaction and/or on the profile of the user. For example, a particular Attestation Appliance is used only for attesting the authenticity of document transfers, while another Attestation Appliance is used for attesting the authenticity of teleshopping orders, etc. Alternatively, or in combination with the above, all interactions initiated by a particular user have the authenticity attested with the help of one or more particular Attestation Appliances with whom the user for example concluded a service agreement.

In the above examples, the Universal Signature Assistant 15 and the remote Attestation Appliance 40 build a secure communication channel 30 between them over a distributed communication network 20, for example over the Internet. The secure communication channel 30 can be built at least partly over a wireless communication link. The Universal Signature Assistant 15 is thus for example directly connected to a mobile telephony network, for example a GSM or a UMTS network, or to a private or public Wi-Fi network. Alternatively, the Universal Signature Assistant 15 is locally connected, for example over a Bluetooth, infrared or USB connection, to a computer or another electronic device which is in turn connected to the distributed communication network. The secure communication channel 30 is then built through the computer or other electronic device.

In an embodiment, the storage 6 of the Universal Signature Assistant 15 is logically or physically divided into a secure area and a non-secure area. The secure area preferably comprises all information and/or pieces of software necessary for establishing the secure communication channel with the Attestation Appliance and/or for identifying the user and/or authenticating his identity. The secure area is also possibly used for securing any confidential interaction data, for example a confidential document received in the course of an interaction. The secure area of the storage is in particular protected against any undesired change that might be initiated by a cybercriminal wanting to take over control of the secure communication channel, for example by changing some of the parameters used for establishing this communication channel.

The access rights to the secure area of the storage 6 are preferably determined on the basis of the user's profile, thus allowing access to some of the parameters and/or documents contained therein only to some selected users.

1. A method for digitally attesting the authenticity of an interaction, comprising the steps of:
establishing a secure digital communication channel between a Universal Signature Assistant and a remote Attestation Appliance,
sending an interaction request to a remote site,
digitally receiving from said remote Attestation Appliance on said Universal Signature Assistant an attestation request for the authenticity of said interaction request,
confirming or denying the authenticity of said interaction request by respectively accepting or rejecting said attestation request on said Universal Signature Assistant.

2. The method of claim 1, further comprising the step of displaying the key features of said interaction to a user.

3. The method of claim 1, wherein said remote site sends an attestation request to said Attestation Appliance to attest the authenticity of said interaction.

4. The method of claim 1, wherein the Universal Signature Assistant is used online to exchange interaction data with said Attestation Appliance.

5. The method of claim 1, wherein the Universal Signature Assistant is used offline to confirm the authenticity of said interaction request.

6. The method of claim 1, further comprising the step of identifying said user on the Universal Signature Assistant.

7. The method of claim 6, further comprising the step of authenticating the identity of said user on said Universal Signature Assistant.

8. The method of claim 1, wherein multiple users get different access rights to the same attestation request or interaction data based on a respective user profile.

9. The method of claim 8, wherein said user profile is downloaded on said Universal Signature Assistant from said Attestation Appliance.

10. The method of claim 8, wherein said user uploads and/or stores interaction data on said Universal Signature Assistant.

11. The method of claim 1, wherein interaction data is uploaded and/or stored on the Universal Signature Assistant by said remote site by sending the interaction data through said Attestation Appliance.

12. The method of claim 11, wherein interaction data stored on said Universal Signature Assistant is accessed by said user and by said remote site.

13. The method of claim 8, wherein the remote Attestation Appliance is chosen based on a particular user profile.

14. The method of claim 1, wherein the remote Attestation Appliance is chosen based on a particular type of interaction.

15. A device for digitally attesting the authenticity of an interaction, comprising a Universal Signature Assistant comprising:
a CPU,
a memory
a storage
a system bus, said CPU, said memory and said storage being connected to said system bus for communicating with each other over said system bus,
a display connected to said system bus for displaying information to a user,
a user input device connected to said system bus for allowing the user entering information to the Universal Signature Assistant,
a communication interface connected to said system bus for communicating with external devices,-a reader for reading user identity information contained on an identity token,
a software program stored in said storage for performing the method of one of the previous claims with said Universal Signature Assistant when said software program is run by said CPU.

16. The device of claim 15, wherein the communication interface is connected to an antenna for wireless communications and/or to a connector for wired communications with external devices.

17. The device of claim 15, said Universal Signature Assistant further comprising a cryptographic co-processor for encrypting and/or decrypting at least part of the data that is sent and/or received over the communication interface.

18. The device claim 15, further comprising an identity token independent from said Universal Signature Assistant.

19. The device of claim 15, said Universal Signature Assistant further comprising a biometric authentication device.

20. The device of claim 15, storing a plurality of user profiles corresponding to several users.

21. The device of claim 15, wherein said storage is logically or physically separated into a secure area and a non-secure area.

22. The device of claim 15, wherein the access rights to said secure area are determined by a user profile.
